(19) United States
(12) Patent Application Publication
(10) Pub. No.: US 2008/0105503 A1
(43) Pub. Date: May 8, 2008

(54) AXIAL ROTARY EDDY CURRENT BRAKE WITH SELF-ADJUSTABLE BRAKING FORCE

(76) Inventor: EDWARD M. PRIBONIC, Seal Beach, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/935,553

(22) Filed: Nov. 6, 2007

Related U.S. Application Data
(60) Provisional application No. 60/857,578, filed on Nov. 8, 2006.

(51) Int. Cl. H02K 49/04

(52) U.S. Cl. 188/267

(57) ABSTRACT

An axial rotary eddy current brake with self adjustable braking force includes two spaced apart support structures defining a gap therebetween, at least two permanent magnets opposingly disposed in said gap and supported by the support structure in a spaced apart relationship and a diamagnetic disk disposed for rotation between the magnets, rotation of the disk causing an eddy current braking force between the magnets and the disk. Biasing apparatus is provided for moving at least one of the magnets as a function of disk rotational speed in order to control the braking force.

This present invention relates to industrial equipment such as drive systems, conveyors, lifting hoists, paper rollers, metal strip rolling mills, moving equipment, vehicles wind mills and the like and more particularly to an eddy current brake for providing a constant or variable torque for controlling the mentioned equipment. This invention also relates to any type of equipment wherein linear or other directional motions can be translated into rotary motion, (as through chains, pulleys, linkage mechanisms, slides and the like), and the subject invention can subsequently be utilized as a brake, speed control, clutch, governor or other similar apparatus.

Rotary mechanical friction brakes have been employed in many industrial applications, such as brakes, clutches, power transmission, or damping systems. The main advantage of the present invention, with respect to traditional mechanical friction brakes, clutches, retarding devices or tensioners, is represented by the absence of friction and elimination of worn or failed components.

Other rotary eddy current brakes in the field are for the most part electromagnetic devices that generally have no resistance controlling mechanism. When a control system is utilized it is usually some version of voltage control to change the strength of the magnetic field via the coils. This type of mechanism becomes complex, costly and is susceptible to failure.

The present invention capitalizes on, (among other operating parameters), the unique changes in magnetic field strength and braking force resulting from changes in speed, distance between magnets and disk(s), and magnet positional relationships, to provide a “sensing logic” and a self produced “actuating force” to change the braking force of the invention in response to changes in a particular operating parameter.

In order to solve the problems of non-uniform torque with changing speed, the main object of the present invention is to provide a brake device that can automatically provide a variable or constant torque through a range of rotational speeds without an electrical control apparatus.

The present invention lends itself to various embodiments of automatic torque adjustability which will be presented below. This automatic, self powered, adjustability represents a feature heretofore unavailable in previous rotary brakes or couplers.

### SUMMARY OF THE INVENTION

An axial rotary eddy current brake in accordance with the present invention which provides for self-adjustable braking force generally includes two spaced apart support structures defining a gap therebetween with at least two permanent magnets opposingly disposed in the gap and supported by the support structure in a spaced apart relationship.

A diamagnetic disk is provided and disposed for rotation between the magnets with rotation of the disk causing eddy current braking force between the magnets and the disk and a biasing means, such as, for example, a spring, is provided for moving at least one of the magnets as a function of disk rotational speed in order to control the braking force.

In one embodiment of the present invention, the magnets are disposed for movement perpendicular to the disk and in another embodiment of the present invention the magnets are disposed for movement parallel to the disk. A further embodiment of the present invention, the magnets are disposed for radial movement with respect to the disk.

One of the support structures may be disposed for movement perpendicular to the disk and the biasing means includes a spring for moving the support structures apart from one another as the rotational speed of the disk increases. Such increased disk rotation causes less magnet attraction between the permanent magnets, thus enabling the spring to move the support structure.

In yet another embodiment of the present invention, the brake includes two spaced apart support structures defining a gap therebetween with at least two permanent magnets opposingly disposed in the gap and supported by the support structure in a spaced apart relationship with magnetic fields in phase with one another. A diamagnetic disk is disposed for rotation between the magnets which rotation of the disk causing an eddy current braking force between the magnets and the disk as hereinabove noted. Biasing means are provided for moving the magnets to cause the magnetic fields to be out of phase with one another as a function of the disk rotation speed in order to control braking force.

The opposing magnets may be linearly aligned with one another with the biasing means linearly moving at least one opposing magnet with respect to another opposing magnet. Alternatively, the biasing means may move the magnets transverse to one another.

Still another embodiment of the present invention, the opposing magnets are radially aligned with one another and the biasing means radially moves at least one opposing magnet with respect to another opposing magnet and a further embodiment of the present invention biasing rotates at least one opposing magnet with respect to another opposing magnet and others to provide out of phase magnetic fields.

Still another embodiment of the present invention, magnet arrays may be provided which are concentrically disposed in the gap and each of the two arrays supported by an opposing support structure with magnetic fields of one array being in phase with an opposing magnetic array.

### BRIEF DESCRIPTION OF THE DRAWINGS

The advantages and features of the present invention will be better understood by the following description when considered in conjunction with the accompanying drawings, in which:

FIG. 1 is a perspective view of one embodiment of the present invention generally showing two spaced apart support structures defining a gap therebetween with permanent magnets opposingly disposed in the gap and is supported by the support structure in a spaced apart relationship along with a diamagnetic disk disposed for rotation between the magnets and a spring, which provides biasing means, for moving the magnets as well as the structure as a function of disk rotational speed in order to control the braking force;

FIG. 2 is a side view of the embodiment shown in FIG. 1;

FIG. 3 is a plot of braking force versus rotational speed for various air gaps;

FIG. 4 is a plot of separation force versus rotational speed for various air gaps;

FIG. 5 is a perspective view of an alternative embodiment of the present invention in which the magnets are movable on the support structure by springs in order to control the phase alignment of opposing magnets, not shown in FIG. 5;

FIG. 6 is a diagram of an embodiment of the present invention in which the magnet arrays are mounted for translational movement with regard to one another;

FIG. 7 is a perspective view of yet another embodiment of the present invention in which concentric arrays of magnets are utilized;

FIG. 8 is a diagram of concentrate magnetic arrays; and

FIG. 9 illustrates the back of a mounting structure along with slots for enabling radial movement of the magnets illustrated in FIG. 8 and the spring through a biasing same.

### DETAILED DESCRIPTION

The present invention relates to an axial, automatic, self adjustable, rotary brake device using eddy current resistance, having an annular rotating conductive reaction disk fastened on a central axle, having a frame, and fitted with permanent magnets disposed on either side of said disk, wherein the magnets produce a magnetic field through the disk. Relative motion between the disk and magnets, produces eddy current resistance opposing the movement of the disk. The magnets may be mounted such that their respective positions relative to each other and thus to the intermediate conductive disk can be changed by an adjusting force, generated by the braking force, (drag), of the device itself, to increase or decrease the space between magnets and disk, (air gap) without the necessity of powered actuators or control systems.

The present invention can also be so configured to provide a reduced torque output until a specific, greater predetermined rotational speed is achieved, and at that point, the device will self-actuate to apply a greater torque output until the rotational speed is reduced to it's original level, accomplishing this without any control apparatus or powered actuating apparatus.

In one embodiment to the present invention, apparatus is provided for adjusting the eddy currents induced in the disk, (and thus the braking force), as a function of rotational velocity of the disk relative to the magnet arrays. Thus, rotating apparatuses, upon applying the brake, can be decelerated, or held at a preferred RPM, (revolutions per minute), in accordance with the present invention.

More specifically, this embodiment may utilize a spring or similar force mechanism, attached to the movable array(s) of permanent magnets that provides means for enabling the lateral movement of the movable magnet array(s) as a function of RPM of the disk between the magnetic arrays. In this way, the braking force is automatically adjusted upon changes to the relative velocity between the disk and the magnet arrays.

Other embodiments to the present invention are defined below to illustrate multiple devices and methods for obtaining automatic self-adjusting of braking power (torque), through the use of various mechanisms.

An eddy current brake 10 in accordance with the present invention generally includes a diamagnetic or non-magnetic disk 12, a first support structure 16 and a separate second support structure 18 disposed in a spaced apart relationship with the first support structure for enabling the disk 12 to rotate therebetween.

With specific reference to FIG. 2, a first array of permanent magnets 12 is disposed on the first structure 16 on a side 24 facing the second structure 18 and a second array of permanent magnets 28 is disposed on the second structure 18 on a side 30 facing the first structure 16. The first and second arrays 22, 28 are parallel with one another and spaced apart from one another in a gap 34 for allowing rotation of the disk 12 therebetween and causing eddy currents to be induced in the disk 12 which results in the braking force between the magnets 22, 28 and the disk 12. No magnetic connection, such as a rigid yoke, (not shown) is required between the structures 16, 18 or the arrays of permanent magnets 22, 28. This feature enables adjustability of the distance between the disk 12 and the magnet arrays 22, 28.

In accordance with the present invention, a means 36 is provided for automatically moving at least one of the first and second structures 16, 18 and magnets 22, 28 along an axis 38 of a shaft coupled to the disk 12 for causing rotation thereof by an external means.

This increases or decreases the gap 34 between structures 16, 18, in order to control eddy currents induced in the disk 12 during the rotation of the disk 12 therebetween, thereby adjust braking force between the magnets 22, 28 and the disk 12.

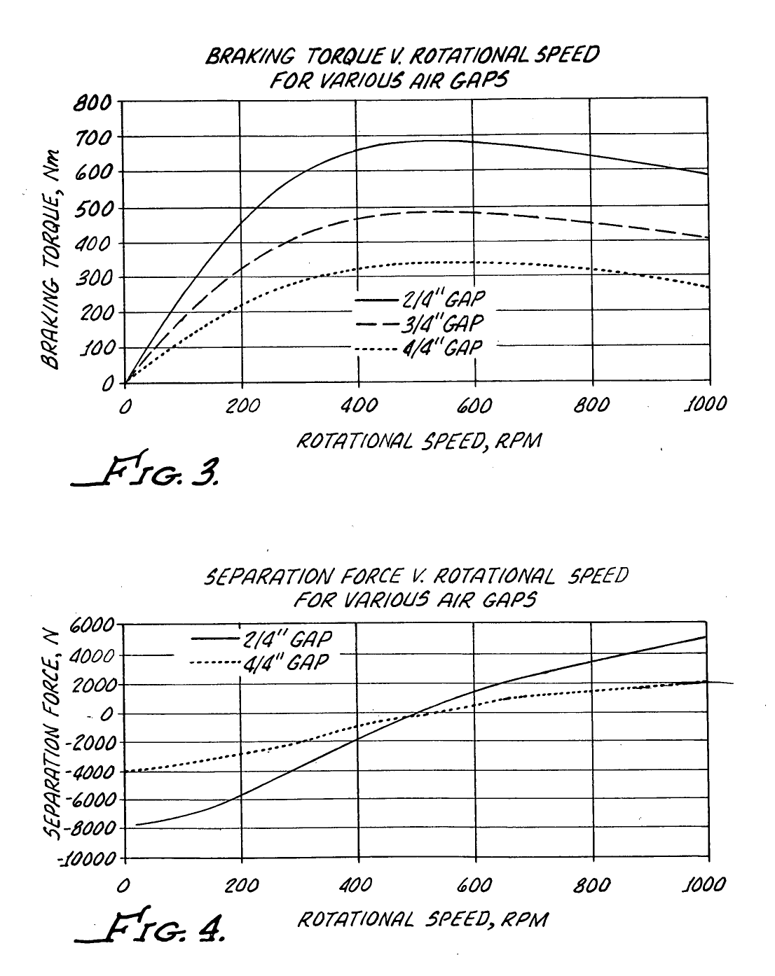

An important principal of eddy current brake performance is that as rotary speed of the disk is increased, the braking force (torque), increases incrementally, then achieves a peak braking force, and subsequently decreases as rotational speed further increases. This is shown in FIG. 3, which plots torque as a function of speed for three different air gaps between opposing magnet arrays.]

Concurrent to the torque, repulsive forces are also produced between magnet arrays, are created from motion-induced Eddy currents in the disk. This observable fact is presented in FIG. 4.

In order to achieve an automatic self-adjustment of air gap, (between opposing magnet arrays), and thus an adjustment, (variance) in braking force, (torque), an actuating force may be placed on the first structure 16, (FIG. 2). In this explanatory embodiment, and for the sake of simplicity, the spring 36 will be used to illustrate the principal, although any number of other actuating forces or means may be utilized. The spring 36 is placed such that it will be in compression due to magnetic attraction between structures 16, 18. A corresponding spring 46 may be placed in an operative relationship with the second structure 18. The springs 36, 46 may have a spring constant such that at zero rotation speed, the spring force is less than the magnetic attraction force between the arrays, but applied in the direction opposite of the attraction.

As shown in FIG. 3, Gap ¾″, that as rotational speed increases, the normal reaction would be that the brake force would increase in proportion to the speed. However, as the braking force increases, induced magnetic fields form which reduce the magnetic attraction between the magnet arrays 16, 18, FIG. 4, permitting the springs 36, 46 to move structures 16, 18 apart, thus widening the air gap 34. The subsequent wider air gap 34 has the effect of reducing braking force, (i.e., FIG. 3, Gap 4/4″), subsequently offsetting the increasing (speed induced) braking force and maintaining a relatively constant brake force with increasing speed.

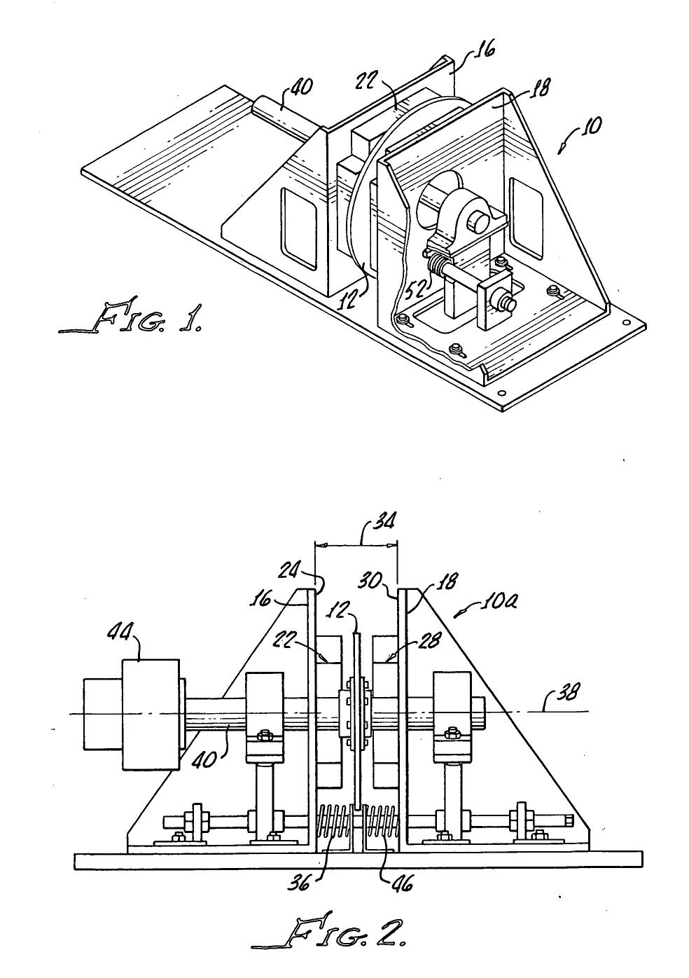

Alternatively, the brake 10, see FIG. 1, may be configured to increase braking force beyond the point of peak drag force indicated on the Drag vs. Speed performance graph which would provide protection against ever increasing rotational speeds, or “runaways”. This is accomplished by reversing the direction of action of the actuating force, (springs 52 in this example), such that the spring force would push the structures together as the magnetic attraction is reduced with speed, (FIG. 4), thereby reducing the air gap. Identical or substrate similar elements in FIGS. 1 and 2 are indicated by common reference character. The brake 10 functions in a reverse manner to that described in connection with the brake 10a hereinabove described, by closing the air gap thus increasing the drag force, (i.e., FIG. 3, Gap 2/4″). The subsequent narrower air gap 34 has the effect of increasing braking force, thus offsetting the decreasing (speed induced) braking force (to the right of the drag peak as shown in FIG. 3), and either maintaining a constant brake force, or increasing the brake force with increasing speed.

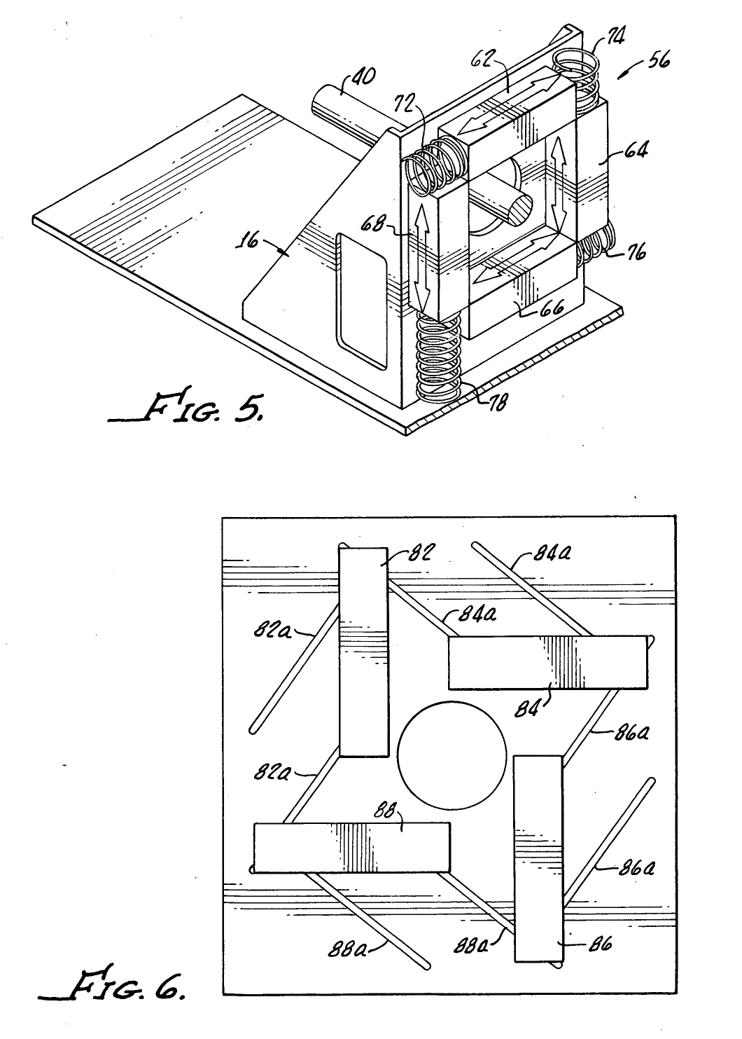

With reference to FIG. 5, there is shown an another automatic self actuating brake embodiment 56 with common reference characters representing identical or substrate similar elements hereinbefore described. In this embodiment 56 four magnet arrays 62, 64, 66, 68 oriented in a square pattern on each of the two structures 16, 18. Any number of magnet array 62, 64, 66, 68 configurations (not shown) may be utilized in brake 56 as presented in FIGS. 6 through 10. On at least one structure 16, the magnets 62, 64, 66, 68 are held via retaining means, springs 72, 74, 76, 78 for example, see FIG. 5, in a position, laterally off set from the magnets of the opposing structure (not shown in FIG. 5), by a distance equal to or less than, ½ wavelength of the array.

In general, it should be understood by those skilled in the art, that magnetically aligned, opposing arrays of magnets will exert a force in a direction that would re-align the arrays. By offsetting the arrays, the communicating magnetic field between the two arrays is diminished, and consequently, braking force is likewise diminished.

This rotational brake embodiment 56 may operate through a range of speeds from zero up to some desired speed, at which point, the drag forces induced by the eddy currents in the disk(s) (not shown in FIG. 5), would exert a reaction force upon the magnet arrays 62, 64, 66, 68 of such strength as to overcome the retaining spring 72, 74, 76, 78 forces. As the retaining springs 72, 74, 76, 78 are overcome, the magnet 62, 64, 66, 68 will be attracted to a more aligned position relative to the opposing array (not shown). With greater alignment, a greater magnetic flux field is produced between the arrays and trough the disk 12, which in turn results in higher braking forces on the disk 12. Thus, the brake 56 applies increasing torque, until, at a predetermined rotational speed the alignment is correct and the maximum braking force possible with the arrays 62, 64, 66, 68 can be achieved at the proper speed.

The speed at which maximum braking force is applied, can be set by the size of springs 72, 74, 76, 78 or the adjustment of the retaining spring mechanism. Another useful and valuable function of this embodiment is that as the rotational speed is controlled by the braking force, and as the speed returns to the desired value, the drag force is reduced to a level where the retaining spring 72, 74, 76, 78 force cannot be overcome. Thus, the retaining springs 72, 74, 76, 78 begin to return the arrays to a mis-aligned position, which again automatically reduces braking force and prevents “over braking” of the device. The result of this configuration is an automatic, self adjusting speed control. Having identified this fundamental application of magnetic and eddy current principals, one skilled in the art can be easily applied to this many other moving and/or releasing mechanisms for automatic control of rotary eddy current brakes.

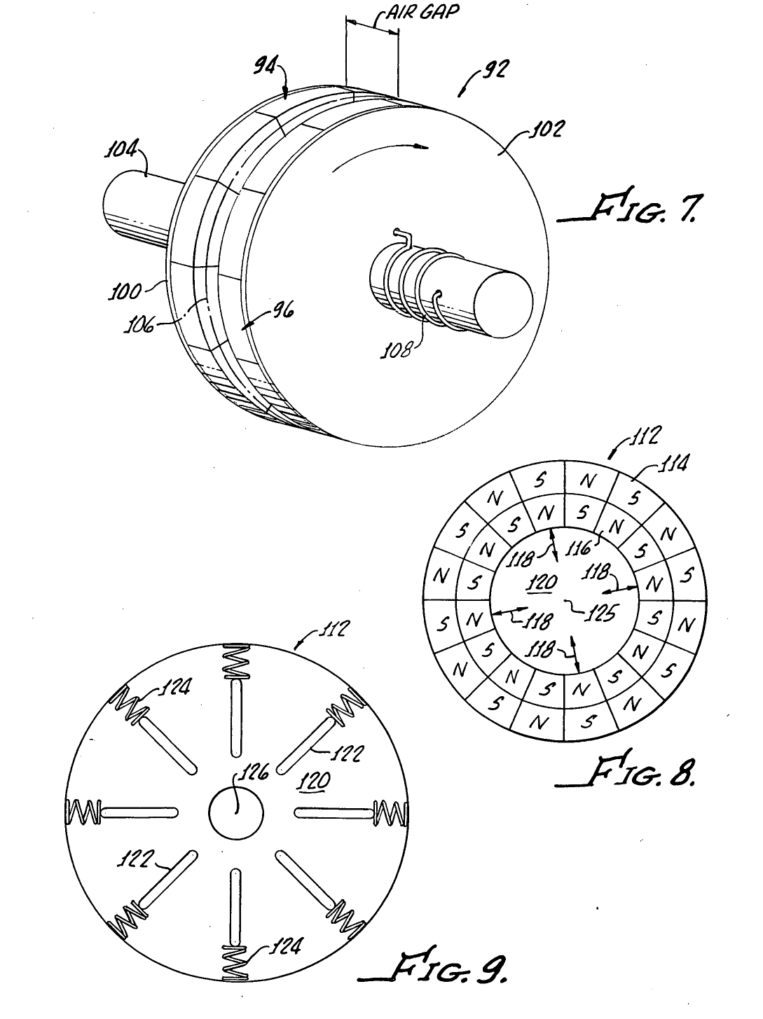

FIG. 6 diagrams a magnet 82, 84, 86, 88 arrangement disposed in a manner with slots 82a, 84a, 86a, 88a enabling transverse movement of the magnets. In another derivative embodiment brake 92 of the misalignment approach involves the use of circular, or radial magnet arrays 94, 96 illustrated in FIGS. 7-10. The described reaction force in this instance is utilized by having one or more rotatable structures 100, 102, being rotational about the same axis or shaft 104 as the disk 106 shown in phantom line. A retaining spring apparatus 108, or other similarly functioning apparatus, is mounted to at least one of the structures 100, 102. As the reaction force increases, (in response to the drag), it overcomes the spring constant and allows rotation of the arrays 94, 96 into an improved alignment with the opposing arrays of the other structures 100, 102. This improved alignment, again, produces a greater magnetic flux field, which in return results in higher braking forces on the disk(s), until the disk(s) speed is retarded to the original value.

Thus, it can be seen that the brake 92 in accordance with the present invention provides for changing the magnetic pole relationship between the arrays 94, 96 of the structures 100, 102 in order to control eddy currents induced in the disk 106 during rotation and adjust a braking force between the magnets 94, 96 and disk 106. The described brake 92 provides for rotationally shifting the opposing magnets “out of phase” with each other to adjust the braking force between magnets and disk.

Accordingly, the amount of tension, retardation, or deceleration provided to a given rotating apparatus may be adjusted and controlled in accordance with the present invention.

It is also clear that combinations of the above embodiments can be configured to expand the capabilities of the invention.

Yet another embodiment brake 112, see FIGS. 8-9, produces a variable braking force by automatically radially adjusting the position of the magnet arrays, (indicated by arrows 118) on a structure thereby utilizing the principal of greater leverage generated as a result of the increasing distance between the fulcrum (shaft/rotational center) and the arrays to generate greater torque.

In this embodiment, magnet arrays 114, 116 are slideably mounted in slots 122 in the structure, and are held in a position close to the rotational center of the invention by, (for example), retainer springs 124, weights (not shown) or other means not shown. The arrays 116, 118 may be mounted to a track arrangement or a linkage arrangement or any other means or mechanism by which the array can translate from it's starting position to it final position. As rotational speed of the disk (not shown in FIGS. 8-9) increases, the reaction force on the arrays 114, 116 will overcome the retaining means through the reaction force of the generated torque. The arrays reaction force will cause the arrays 114, 116 to relocate radially, following the translation means, along the face of the structure 120, thus increasing the distance between the arrays and the rotational center 126. This increasing distance multiplies the torque, or, braking force. As with the previously described embodiments, the full extent of motion of the arrays can be designed to coincide with any desired rotational speed for achieving precise performance in an automatic self-adjusting brake.

Although there has been hereinabove described a specific axial rotary eddy current brake with self-adjustable braking force in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. An axial rotary eddy current brake with self adjustable braking force, the brake comprising:
two spaced apart support structures defining a gap therebetween;
at least two permanent magnets opposingly disposed in said gap and supported by the support structure in a spaced apart relationship;
a diamagnetic disk disposed for rotation between the magnets, rotation of the disk causing an eddy current braking force between the magnets and the disk; and
biasing means for moving at least one of the magnets as a function of disk rotational speed in order to control the braking force.

2. The brake according to claim 1 wherein the magnets are disposed for movement perpendicular to the disk.

3. The brake according to claim 1 wherein the magnets are disposed for movement parallel to the disk.

4. The brake according to claim 1 wherein the magnets are disposed for radial movement with respect to the disk.

5. The brake according to claim 1 wherein at least one of the support structure is disposed for movement perpendicular to the disk and said biasing means comprises a spring for moving the one support structure apart from another of the support structures as the disk rotational speed increases, increasing disk rotation speed causing less magnet attraction between the permanent magnets thus enabling the spring to move the one support structure.

6. An axial rotary eddy current brake with self adjustable braking force, the brake comprising:
two spaced apart support structures defining a gap therebetween;
at least two permanent magnets opposingly disposed in said gap and supported by the support structure in a spaced apart relationship with magnetic fields in phase with one another;
a diamagnetic disk disposed for rotation between the magnets, rotation of the disk causing an eddy current braking force between the magnets and the disk; and
biasing means for moving the magnets to cause the magnetic fields to be out of phase with one another as a function of disk rotational speed in order to control the braking force.

7. The brake according to claim 6 wherein the opposing magnets are linearly aligned with one another.

8. The brake according to claim 7 wherein said biasing means linearly moves at least one opposing magnet with respect to another opposing magnet.

9. The brake according to claim 7 wherein said biasing means transversely moves at least one opposing magnet with respect to another opposing magnet.

10. The brake according to claim 6 wherein opposing magnet are radially aligned with one another.

11. The brake according to claim 10 wherein said biasing means radially moves at least one opposing magnet with respect to another opposing magnet.

12. The brake according to claim 10 wherein said biasing means rotates at least one opposing magnet with respect to another opposing magnet.

13. An axial rotary eddy current brake with self adjustable braking force, the brake comprising:
two spaced apart support structures opposing one another and defining a gap therebetween;
at least two permanent magnets arrays, each array concentrically disposed in said gap and each of the two arrays being supported by an opposing support structure with magnetic fields of one array being in phase with an opposing magnet array;
a diamagnetic disk disposed for rotation between the magnets, rotation of the disk causing an eddy current braking force between the magnets and the disk; and
biasing means for moving at least one of the magnet arrays to cause the magnet fields to be out of phase with one another as a function of disk rotational speed in order to control the braking force.

14. The brake according to claim 13 wherein said biasing means radially moves at least one array with respect to the opposing array.

15. The brake according to claim 13 wherein said biasing means rotationally moves at least one array with respect to the opposing array.
